(19) United States
(12) Patent Application Publication
(10) Pub. No.: US 2013/0345910 A1
(43) Pub. Date: Dec. 26, 2013

(54) DETECTOR FUNCTION AND SYSTEM FOR PREDICTING AIRFOIL STALL FROM CONTROL SURFACE MEASUREMENTS

(71) Applicants: Michael F. Kerho, Thousand Oaks, CA (US); Michael B. Bragg, Champaign, IL (US); Phillip J. Ansell, York, PA (US)

(72) Inventors: Michael F. Kerho, Thousand Oaks, CA (US); Michael B. Bragg, Champaign, IL (US); Phillip J. Ansell, York, PA (US)

(73) Assignee: THE BOARD OF TRUSTEES OF THE UNIVERSITY OF ILLINOIS, Urbana, IL (US)

(21) Appl. No.: 13/371,955

(22) Filed: Feb. 13, 2012

Related U.S. Application Data
(60) Provisional application No. 61/442,054, filed on Feb. 11, 2011.

(51) Int. Cl. B64D 43/02

(52) U.S. Cl. CPC B64D 43/02
USPC 701/14

(57) ABSTRACT

Methods and apparatus for predicting airfoil stall for an aircraft having a control surface. Measurements of forces or moments acting upon an integrated span of the control surface are sensed over a period of time to provided unsteady data. The unsteady data is filtered to remove structural frequencies and input to at least one stall warning detection function, and an output is received. Each of the stall warning detection functions identifies an angle-of-attack that is approximately within a predetermined number of degrees of stall when the received output reaches a threshold. The received output is compared to the threshold to determine whether an angle-of-attack exists that is near stall.

### PRIORITY CLAIM AND REFERENCE TO RELATED APPLICATION

This application claims the benefit of U.S. Provisional Application Ser. No. 61/442,054, filed Feb. 11, 2011, under 35 U.S.C. §119.

### STATEMENT OF GOVERNMENT INTEREST

This invention was made with Government support under Contract No. NNX09CF54P awarded by NASA. The Government has certain rights in the invention.

### FIELD OF THE INVENTION

A field of the invention is detection functions and systems for vehicles. Example applications of the invention include performance and controllability monitoring and stall prediction for aircraft.

### BACKGROUND OF THE INVENTION

Currently, a problem exists when an aircraft encounters conditions that could cause contamination on an airfoil. The airfoil is the two-dimensional cross-section of a wing or tail of which a control surface, such as a flap, rudder, or elevator, can be a part. As one example of contamination, an ice shape can form on the airfoil surface, causing a reduction of lift, increased drag, and change in quarter-chord pitching and control surface hinge moments of the airfoil. The presence of the contamination alters the surface pressure distribution over the airfoil, which leads to these changes in performance.

Airfoil surface contamination can also lead to premature airfoil stall at high angles-of-attack or large flap deflections, and potentially cause a loss of control of an aircraft. Stall is caused by the separation of the boundary layer from a surface, commonly due to an adverse pressure gradient. A contamination-induced separation can have negative consequences on the controllability of an aircraft. For example, a premature airfoil stall may occur as a result of ice accretion, leading to a reduction of the pressure acting on the upper surface of a control surface, which imposes an upward unsteady force that acts to deflect the control surface in that direction. The flap is essentially sucked upward by the lower pressure, which can lead to undesirable changes in the aircraft controllability.

This abrupt contamination-induced flow separation can lead to a sudden significant change in hinge moment, leaving insufficient time for a flight crew to react correctly. Such occurrences have led to aircraft accidents in the past. Therefore, it is desirable to sense impending problems and to develop systems to correct or protect against them before an accident becomes inevitable.

Another level of protection has been proposed to increase in-flight pilot awareness by providing information on current and predicted aircraft performance and controllability, alerting the flight crew to any aerodynamic degradation of the control effectiveness due to flowfield separation and unsteadiness. In addition to flight beyond the baseline, clean-aircraft flight envelope, such a system will be able to detect a reduction in the envelope due to several in-flight environmental contaminants such as heavy rain, in-flight icing encounters, surface contamination in the form of roughness, and structural damage such as bird strikes or battle damage.

Existing systems monitor potential contamination by measuring surface pressure fluctuations. However, the sensors used only measure contamination effects at a single point on the surface.

U.S. Pat. No. 6,140,942 (incorporated in its entirety herein by reference) to Bragg et al., discloses an aircraft surface contamination sensing system and method. The system and method utilizes a sensor which can be located on or within any control surface, such as a flap, rudder, or elevator. The sensor senses a hinge moment over time. The sensor outputs this information to a processor, which then calculates a control surface hinge moment coefficient. The control surface steady and/or unsteady hinge moment coefficients are analyzed, and the control surface hinge moment coefficient is compared against a clean control surface value. Once the control surface hinge moment coefficient deviates from the clean value but before it reaches a critical value, an appropriate system may be notified. For example, the aircraft flight crew may be alerted and can modify the flight controls accordingly. Alternatively, corrective flight systems could be used.

### SUMMARY OF THE INVENTION

Embodiments of the present invention provide, among other things, methods and apparatus for predicting airfoil stall for an aircraft having a control surface. Measurements of forces or moments acting upon an integrated span of the control surface are taken over a period of time to provide unsteady data. In some example embodiments, the measurements are taken by sensing a control surface hinge moment for a hinge connected to the control surface. The unsteady data is filtered to remove structural frequencies. The filtered unsteady data is input to at least one stall warning detection function, and an output is received. Each of the stall warning detection functions identifies an angle-of-attack that is approximately within a predetermined number of degrees of stall when the received output reaches a threshold. The received output is compared to the threshold to determine whether an angle-of-attack exists that is near stall.

### BRIEF DESCRIPTION OF THE DRAWINGS

FIG. 1 is a block diagram of a sensing system constructed in accordance with embodiments of the present invention;

FIG. 2 is an isometric cross-sectional view of an aircraft wing;

FIG. 3 is a top view of an aircraft wing, illustrating dimensions used in example calculations;

FIG. 4 is a flow chart illustrating example methods of the invention;

FIG. 5 shows an experimental output of moment, derivative, and spectrum based detector function outputs for a clean NACA 3415 model as a function of an angle-of-attack, α, at Re=1.8×10⁶, and a 0° flap angle;

FIGS. 6A-6C show an experimental detector threshold boundary determination for moment function output (FIG. 6A), derivative function output (FIG. 6B), and spectrum function output (FIG. 6C) for the clean NACA 3415 model and a model with six simulated contaminants as a function of an angle-of-attack, α, at Re=1.8×10⁶, and a 0° flap setting;

FIG. 7 shows an experimental effect of flap angle on detector function threshold level for a warning boundary of 2° for the NACA 3415 model, for Re=1.8×10⁶;

FIG. 8 shows an experimental envelope warning prediction based on developed detector functions for the NACA 3415 clean model and the model with simulated contaminants as a function of flap angle, for Re=1.8×10⁶ and a warning boundary of 2°;

FIGS. 9A-9C show an example primary (mother) wavelets Sym2 (FIG. 9A), Haar (FIG. 9B), and Coif2 (FIG. 9C) chosen for an example NACA 23012 analysis;

FIGS. 10A-10F show experimental unsteady hinge moment signal denoising and thresholding for warning boundary prediction using the Haar wavelet for a clean NACA 23012 model at Re=1.8×10⁶, and a 0° flap setting, where FIGS. 10A shows a clean lift curve, FIGS. 10B-10E show output from the Haar based wavelet transform for four selected points, respectively, and the FIG. 10F shows a percentage of the signal above the baseline zero value; and

FIG. 11 shows an example envelope warning prediction based on the wavelet detector functions for the NACA 23012 clean model and the model with simulated contaminants, for Re=1.8×10⁶, a flap angle of 0°, and a warning boundary of 2°.

### DETAILED DESCRIPTION

In embodiments of the present invention a method to analyze time-dependent data is provided that allows the prediction of airfoil stall and loss of control without the need to compare to the clean, not contaminated, airfoil performance. Example systems can provide envelope protection for the clean airfoil as well as the airfoil with surface contamination.

An embodiment of the invention is a detection method and system used with or as part of an aircraft flight envelope monitoring system, which in example embodiments provides real-time, in-cockpit estimations of aircraft flight envelope boundaries, performance, and controllability. Example embodiments can be provided as part of an adaptable monitoring system that provides information on current and predicted aircraft performance and controllability, alerting a user (e.g., the aircraft's pilot, flight crew, aircraft automation or other on-board controller, etc.) to any aerodynamic degradation of the control effectiveness due to flowfield separation and unsteadiness. In addition to flight beyond the baseline aircraft flight envelope, example systems can detect a reduction in the envelope due to various in-flight environmental contaminants such as heavy rain, in-flight icing encounters, surface contamination in the form of roughness, and structural damage such as bird strikes or battle damage, etc. The example monitoring system is targeted to provide integrated aerodynamic vehicle health management.

Embodiments of the present invention provide a system and method for predicting stall for a vehicle such as an aircraft, having a control surface, which generally refers to a device for adjusting aircraft flight attitude (as nonlimiting examples, ailerons, rudders, elevators, simple flaps, etc.). A sensor or sensors is provided to take measurements of forces or moments acting upon an integrated span of the control surface, and a processor determines unsteady data using these measurements. In example embodiments, the control surface includes or is connected to a hinge, or other element capable of being instrumented, by which fluctuating forces on the aft section of the airfoil can be measured. The sensing system includes a sensor (or sensors) and a processor. A display device may also be used to indicate a user warning It is also contemplated that the processor may output a signal to a computer-based flight management system through which a correction or warning could be made.

The measurements of forces or moments are output to the processor. For example, if the control surface is connected to a hinge, the example sensor (or sensors) senses a control surface hinge moment and outputs this information over time to the processor. A control surface hinge is used in example embodiments because it can be easy to instrument and provides an integrated spanwise measurement. However, example methods of the invention can be used with similar measurements of force or moment on the control surface taken elsewhere on the control surface, so long as these measurements pick up the fluctuations caused by the disturbances in the flowfield that occur prior to stall.

An example real-time monitoring system provides unsteady data by acquiring measurements of the unsteady data, e.g., control surface hinge moment data, from all aircraft aerodynamic controls. Time-averaged hinge moments are obtained in particular example embodiments using (e.g., by calculating the average of) the unsteady hinge moment measurements. These data are processed, and information on the current and predicted future state of aircraft control (including asymmetric cases) is made available to the user. The use of real-time monitoring of forces or moments acting upon the integrated span of the control surface, e.g., control surface hinge moment monitoring, allows an innovative and robust method and system for predicting aircraft performance and controllability. Further, as opposed to other, single point sensor monitoring systems, example systems of the present invention can function by measuring the integrated effect over the entire control surface.

Providing real-time information about the controllability or loss of lift and reduction of the useable flight envelope is critical, since loss of control is one of the primary causes of in-flight accidents. Example hinge moment sensor based aircraft flight envelope monitoring systems can provide an onboard real-time assessment of the current state of the aerodynamic health of the aircraft, alerting the user as controllability boundaries are being approached while the aircraft is still controllable. Additionally, example methods and systems can provide a real-time assessment of the overall change in aircraft performance and controllability due to both environmental and structural hazards.

Example systems and methods of the present invention can employ control surface hinge moment measurements as a system for sensing aerodynamic lift and/or controllability loss, such as but not limited to the systems and methods described in U.S. Pat. No. 6,140,942. Such example systems and methods take the hinge moment data and process the information to provide a reliable and robust stall prediction function based on the hinge moment results. Preferred systems and methods can be used to provide an accurate warning of stall several degrees angle-of-attack prior to actual stall, alerting the user to the current aircraft envelope boundaries for both longitudinal and lateral control.

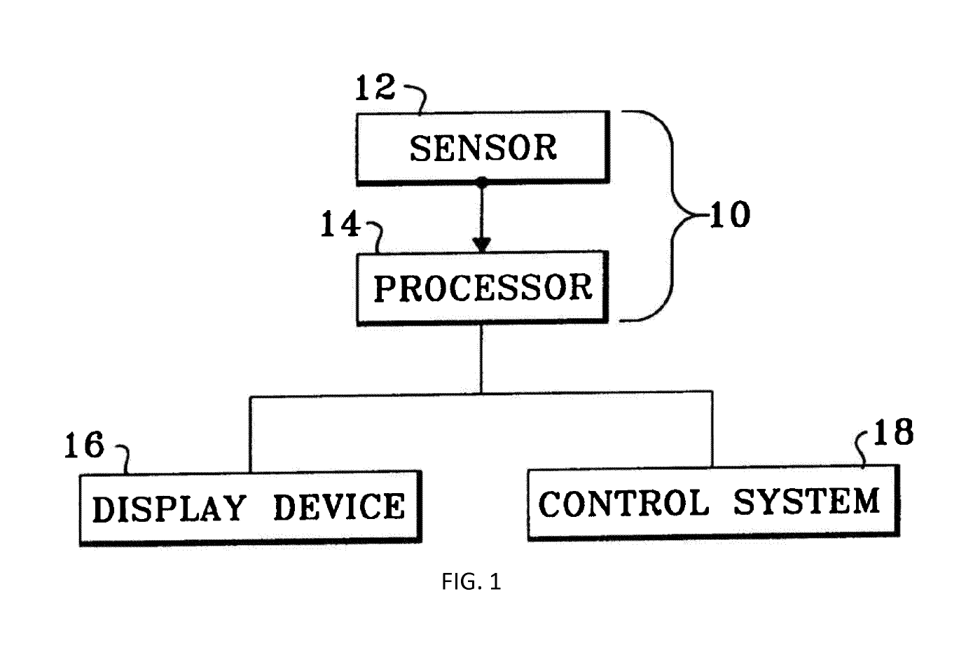

Turning now to the drawings, FIG. 1 shows a block diagram of an example system 10. The system 10 includes a sensor or sensors 12 for measuring forces or moments acting upon the integrated span of the control surface and a processor 14 for analyzing these data. The sensing system output may be directed to a display or other output device 16 for displaying a warning should it be needed (or a current status if no warning is currently needed). Also shown is a flight control system 18. It is contemplated that the processor 14 could output to the flight control system 18 as an alternative to or in addition to the display 16. The example sensor 12 may be a standard strain gauge sensor, which measures the control surface hinge moment. Other devices capable of detecting the hinge moment, directly or indirectly, or otherwise capable of measuring forces or moments acting upon the integrated span of the control surface are also suitable. The sensor 12 may be mounted within the control surface to protect it from the environment and minimize its effect on the wing surface flowfield.

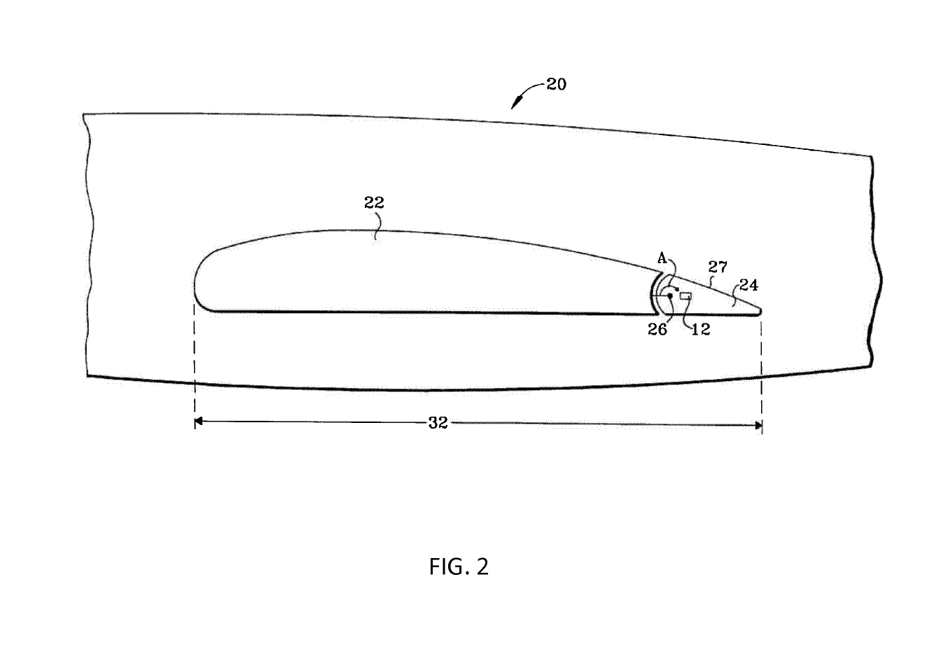

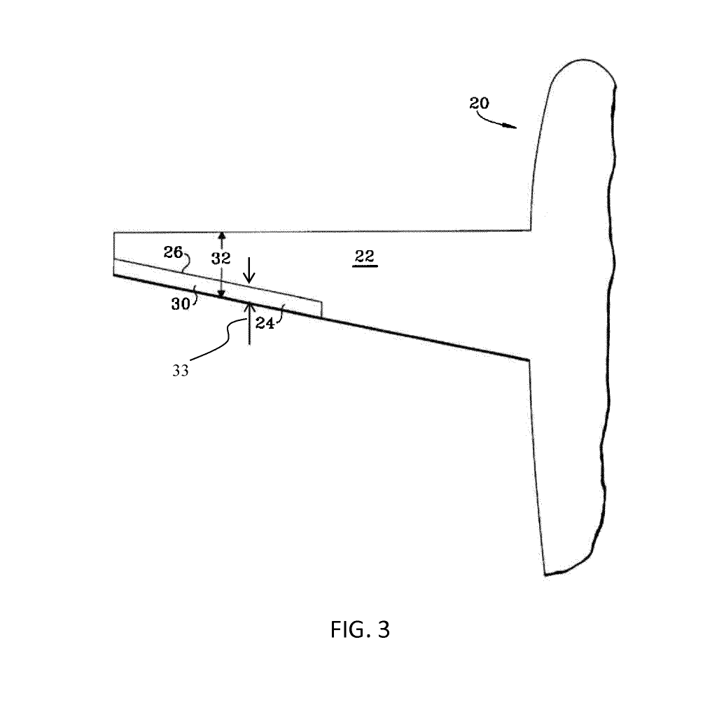

Referring to FIG. 2, the function of the sensor system 10 will now be described with respect to an aircraft, generally labeled 20. In particular example systems and methods described with respect to FIGS. 2-4, the sensor 12 measures forces or moments acting upon the integrated span of the control surface by measuring a control surface hinge moment for a hinge connected to the control surface. The example sensor system 10 is for use on an aircraft 20 of standard design, for instance, having a hinged control surface such as a flap. In FIG. 2, a wing 22 with a control surface such as a simple flap 24 is shown. As illustrated, the flap 24 includes a hinge line 26, which has a control surface hinge moment indicated by an arrow A. The wing 22 (having chord length 32) can be contaminated, for example, with ice or other contaminants, such as surface roughness, heavy rain, damage due to bird strikes, etc. Dimensionally, the flap 24 includes a control surface area 30 and a control surface chord length 33 (from the leading edge of the flap near hinge line 26 to the trailing edge of the flap), best seen in FIG. 3. The measurements of the control surface area 30 and the control surface chord length 33 are preferably constant values that can be stored for use by the processor 14.

Nonlimiting examples of a processor 14 include a suitable configured computer (including as part of or separate from control systems for an aircraft), a CPU, a suitably programmed chip (e.g., ASIC) or board, etc. The processor 14 can be any suitable processor for analyzing the data according to methods of the claimed invention, and can be controlled using instructions stored within hardware, firmware (including hardware of firmware of the processor or elsewhere), or stored as software instructions on a non-transitory, tangible medium for reading and executing by the processor. The processor may be coupled to the sensor or sensors 12 wired or wirelessly using methods and devices known to those of ordinary skill in the art.

The sensor (or sensors) 12 is preferably mounted within the flap 24. If internal mounting is not possible, the sensor 12 can be externally mounted and faired such that no flowfield unsteadiness is created that significantly affects the flap hinge moment. Also preferably stored for use by the processor 14 is information sufficient to calculate the dynamic pressure, i.e., the kinetic energy of the surrounding air. The dynamic pressure can be calculated by taking one-half of the air density times the velocity of the aircraft squared, and accordingly can be calculated by the processor 14 based upon a measured air speed. The measured air speed may be provided by the processor 14, for instance, by conventional flight systems used to detect air speed.

In instances of stall for both clean aircraft and contaminated aircraft, such as (for example only) due to a high ice ridge formation on the aircraft wing 22, a loss of lift and the potential for a loss of aircraft controllability exist. Thus, it is desirable for the sensor system 10 to be able to predict impending problems before they occur, to give the user ample time to react and alter the control system.

A preferred method and system uses a prediction calculation that is consistent across the widest range of environmental conditions, such as but not limited to icing, surface roughness, damage from bird strikes, heavy rain, etc. Example systems and methods detect changes in the aerodynamics of the section and provide a warning as to the reduced margins. Current, real-time data are preferably used, without a priori knowledge of the state of the section, aircraft, or past events, though it is also contemplated that certain a priori knowledge could be used. Example systems and methods can account for changes in the aerodynamics of the section as a result of physical changes to the airfoil that can happen either over time, such as with an icing encounter, or instantaneously, such as a bird strike. A warning buffer in example embodiments can be provided to the user approximately (that is, within ±0.7 degrees) within a set number of degrees angle-of-attack, α, prior to stall.

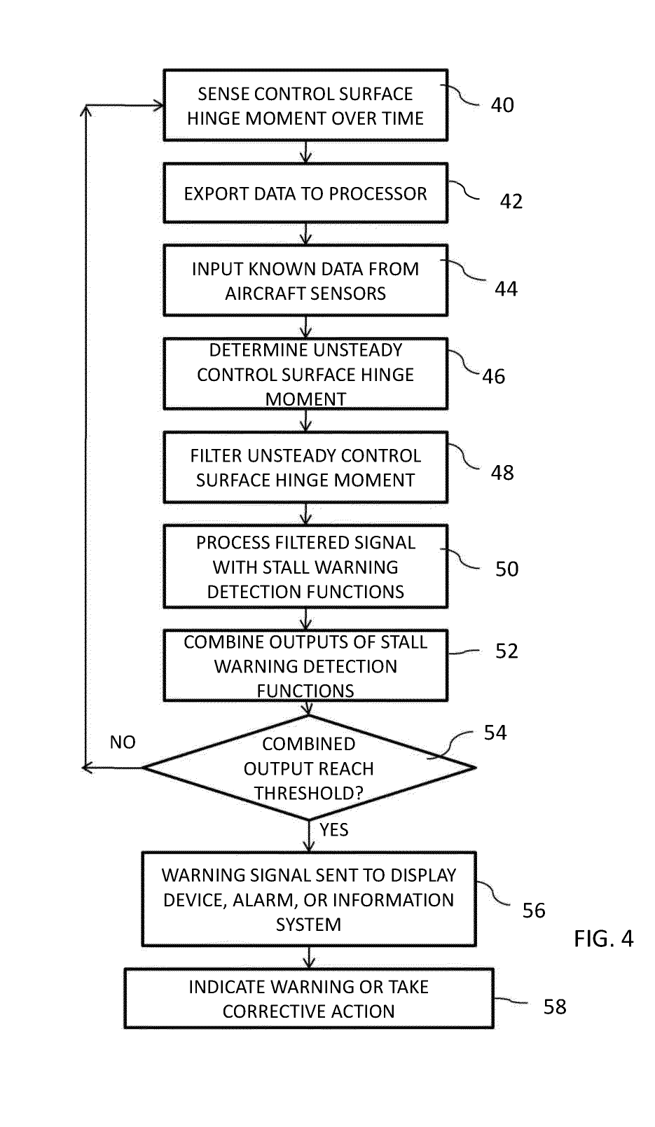

FIG. 4 shows an example method for predicting airfoil stall for an aircraft according to an embodiment of the present invention. The sensor 12, or other suitably located and configured sensor or sensors, senses the hinge moment, indicated by arrow A in FIG. 2, about the control surface hinge line 26 over time (step 40) and generates a plurality of measurements. Each measurement is generated from an unsteady control surface hinge moment signal that represents the control surface hinge moment during the time of acquisition by the processor 14. Data concerning the control surface hinge moment, i.e., the unsteady control surface hinge moment signal, is communicated (e.g., exported) to the processor 14 over some period of time (step 42), producing a time series of unsteady data embodied in unsteady control surface hinge moment data. These unsteady, time-dependent data are time-averaged to produce the steady hinge moment response.

The unsteady hinge moment data is preferably non-dimensionalized by dividing the hinge moment data by known data and measurements from aircraft sensors, such as the control surface area 30, the control chord length 33, and the dynamic pressure, which are stored for use by the processor 14 (step 44), to determine a (control surface) hinge moment coefficient, Cₕ (step 46). The steady hinge moment coefficients ( C̅ₕ); i.e., the non-dimensionalized, time-averaged control surface hinge moment signals, are obtained by time-averaging the unsteady hinge moment coefficients from step 46. Alternatively, the unsteady hinge moment data could be averaged and then non-dimensionalized to obtain a steady hinge moment coefficient.

Using the resulting steady hinge moment coefficient and unsteady (time-dependent) hinge moment coefficients, estimates of the level of unsteadiness in the hinge moment signal can be determined. In example methods, the unsteady hinge moment signal over the period of time is filtered in the processor 14 to minimize, primarily, the influence of structural frequencies present in the signal (step 48). Such structural frequencies include frequencies capable of influencing force or moment measurements acting on the integrated span of the control surface, e.g., hinge moment measurements by the sensor 12. This removes the structural unsteady content that could mask the aerodynamic unsteady content. A nonlimiting example filtering method estimates structural frequencies by exciting a wind tunnel model wind-off and observing the power spectrum output of the hinge moment balance. These estimated structural frequencies are used to determine a suitable filter, e.g., a low-pass filter, through which the unsteady hinge moment signal, e.g., unsteady control surface hinge moment coefficient, Cₕ, is filtered. Other example filtering techniques include, but are not limited to, bandstop filtering and wavelet based denoising.

The filtered unsteady control surface hinge moment coefficient, Cₕ, over time is processed according to embodiments of the present invention to predict airfoil stall and to provide a warning of stall a set number of degrees angle-of-attack prior to stall. Particularly, the filtered unsteady hinge moment coefficient, represented by Cₕ, is processed (step 50) through one or, preferably, a combination of various stall warning detection functions (which can be programmed in the processor 14, for example) for predicting stall at a preset number of degrees angle-of-attack prior to stall. In a nonlimiting example system and method, stall warning detection functions are provided based upon the unsteady hinge moment produced by an aerodynamic control surface. Generally, each of the stall warning detection functions are configured to receive the filtered unsteady hinge moment signal, e.g., filtered control surface hinge moment coefficient Cₕ, as an input, and generate an output that is compared to a threshold to identify the angle-of-attack as being approximately within a certain number of degrees of airfoil stall. Preferably, the stall warning detection function can identify this condition over background noise, and for both clean and for contaminated lifting surfaces of various types. Selection of preferable stall warning detection functions can account for multiple flap angles and various Reynolds numbers.

It is also preferred that the filtered unsteady hinge moment signal is input to each of multiple stall warning detection functions, and the results of the individual detection functions are combined (step 52), e.g., averaged, to produce a combined warning In an example embodiment, for multiple detection functions, the outputs of each individual detection function can be compared to a threshold to create a local angle-of-attack margin, and the margins of each method can be averaged to obtain the final warning boundary. Use of multiple stall warning detection functions helps minimize the effect of outlying results from any particular function. If multiple sensors 12 are used for a single control surface, the outputs of the multiple detector functions could be combined, e.g., averaged, or compared to provide redundancy into the stall warning system.

Two nonlimiting example types of stall warning detection functions are provided according to embodiments of the present invention. One example method and system includes a combination of a moment, derivative, and spectrum based approach (and in some embodiments, time normalized energy), while other example methods and systems include a wavelet-based approach. Both example types of methods can be successful for certain types of airfoil sections. Those of ordinary skill in the art will appreciate that other stall warning detection functions and wavelets are possible for use in processing according to other embodiments of the invention.

If the output (or combined output) generated by the processing (step 50, and step 52 if combined output) exceeds the threshold (step 54), which occurs at an angle-of-attack that is prior to an angle-of-attack for airfoil stall, the processor 14 produces an output signal (step 56), which may be sent to the display device 16, alarm, or information system, for example. In a preferred embodiment, the display device 16 then alerts the user (step 58) so that corrective action, e.g., adjustments to the controls, can be made, avoiding a possible accident. Based on the result from the employed detection function(s), the output signal (step 56) can be a warning signal that is sent to the display device 16. It is also contemplated that the signal could also be input into other aircraft information systems, where the signal could be integrated with other information. Upon receiving a signal, the display device 16 can alert the user (step 58) by displaying a warning signal to the operator. Warnings such as a flashing light, alarm, screen display (e.g., a display containing words such as WARNING and particular conditions), vibration feedback, or other suitable alarm are contemplated.

For purposes of illustration of certain features of example embodiments, hinge moment data are obtained from wind tunnel tests on two different example airfoil sections, a NACA 3415 and a NACA 23012. Data from the NACA 3415 wind tunnel test are first used to develop a nonlimiting example predictive detection function. The NACA 23012 wind tunnel test data is then used to develop an example wavelet based detection method.

In experiments demonstrating nonlimiting example methods according to the present invention, experimental hinge moment data from the NACA 3415 test are used to develop a predictive stall warning function. This example function is based on the unsteady hinge moment signal from a simple flap on the airfoil. The example method and system developed based on the NACA 3415 test data uses a combination of three separate functions to provide a warning at a preset number of degrees angle-of-attack prior to stall. These three functions are based on the unsteady hinge moment time trace, which is represented in particular example embodiments by the filtered unsteady control surface hinge moment coefficient Cₕ, though it is also contemplated to use hinge moment signals without non-dimensionalizing them.

The first example function developed calculates the 4th order moment about the mean of the unsteady hinge moment signal. The 4th order moment is often termed the kurtosis of the signal and is basically a measure of the spread of the signal from the mean ( C̅ₕ). The second example function developed is a time derivative based function of the unsteady hinge moment signal. The example function calculates the square of the first and second derivative of the hinge moment signal, takes a sum of those values, and then an average over the time trace. The example third function integrates the power spectrum (PSD) of the hinge moment time history over a given frequency interval. This approach essentially provides the energy content of the signal over a given frequency range. The three separate example detection functions are provided below:

$$\begin{matrix} Moment = \frac{1}{n} {\sum }_{i = 0}^{n - 1} {( {C}_{h} - {\overline{C}}_{h} )}^{4} & 1 st Function \\ Derivative = \frac{1}{n} {\sum }_{i = 0}^{n - 1} {( \frac{d {C}_{h}^{2}}{d t} + \frac{{d}^{2} {C}_{h}^{2}}{d {t}^{2}} )}^{2} & 2 nd Function \\ Spectrum = {\int }_{0 Hz}^{50 Hz} PSD ( {C}_{h} ) d f & 3 rd Function\end{matrix}$$

Prior to calculating the three example detection functions, the unsteady hinge moment signal coefficient is filtered, e.g., low-pass filtered, as explained above, to remove any (or a substantial amount of) structural frequencies present in the signal. The structural frequencies are estimated during an example test by exciting the model wind-off and observing the power spectrum output of the hinge moment balance. These structural frequencies for the NACA 3415 model were on the order of 200-500 Hz. The example low-pass filter cut-off frequency was set at 50 Hz.

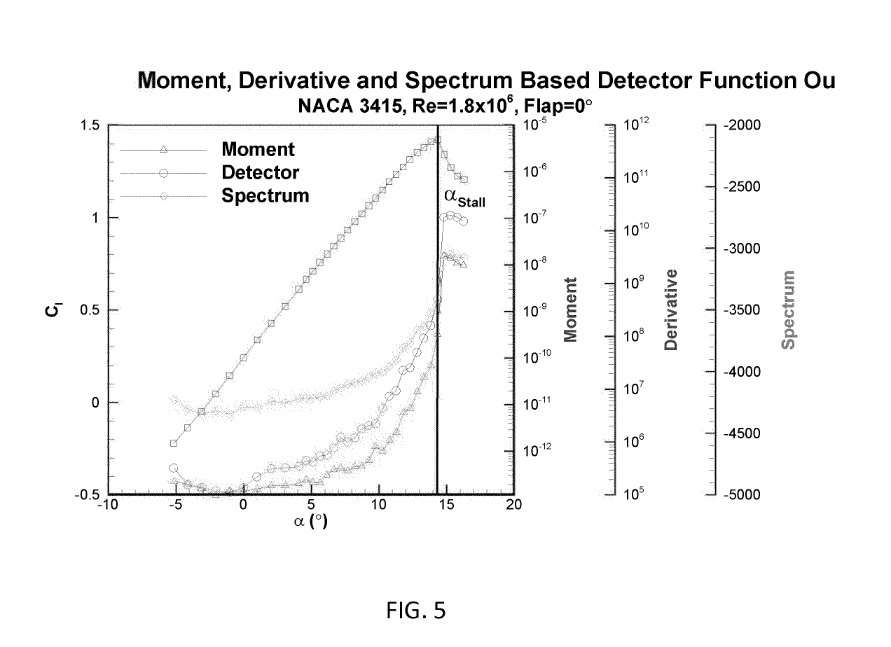

A plot showing the output of the three example detector functions for the clean NACA 3415 model as a function of angle-of-attack at Re=1.8×10⁶ and 0 degree flap angle is shown in FIG. 5. Also included in the figure are the lift curve and a line denoting αₛₜₐₗₗ. As shown in FIG. 5, each of the detector functions produces a relatively smooth output, which significantly increases in magnitude several degrees prior to stall. Above α=0°, the functions provide a monotonic increase in level with increasing α until stall. In addition to increasing magnitudes as stall is approached, the slope of each of the detector function outputs is also shown to increase. Using a threshold based approach, the three example detector functions appear to provide sufficient output and a large enough signal-to-noise ratio to be used as accurate predictive indicators of stall several degrees angle-of-attack prior to stall.

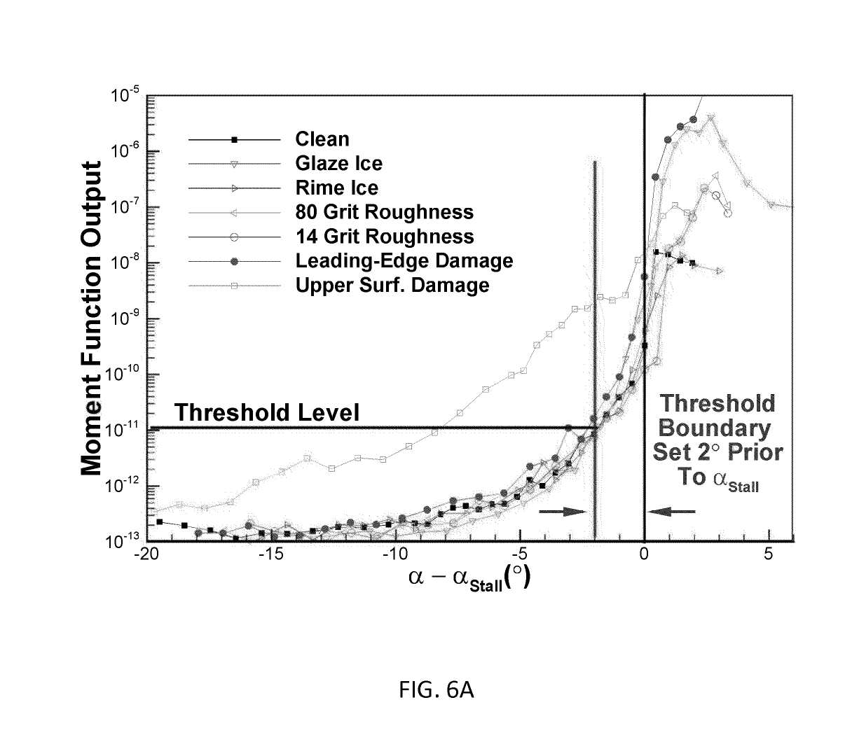

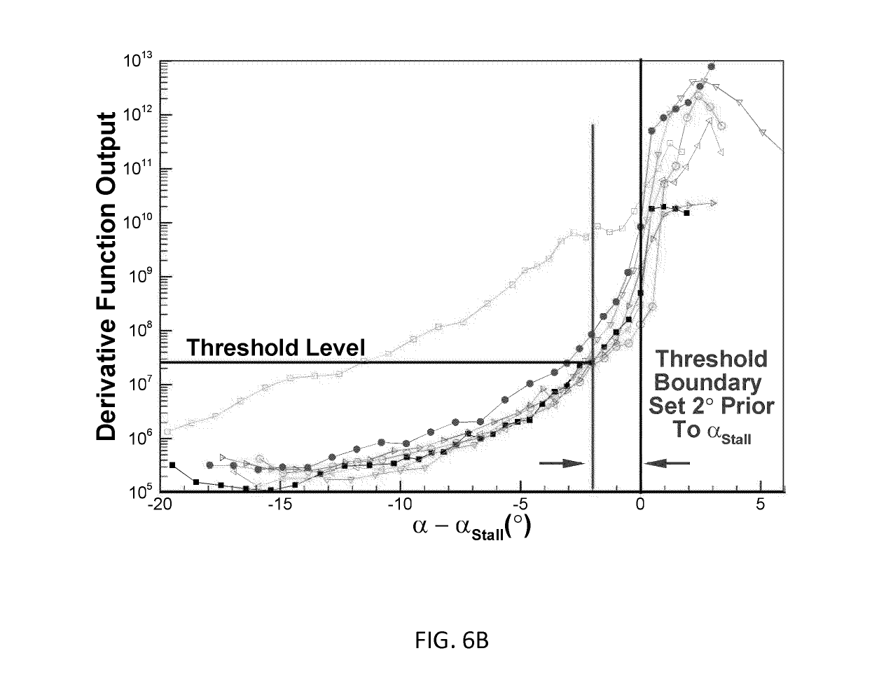

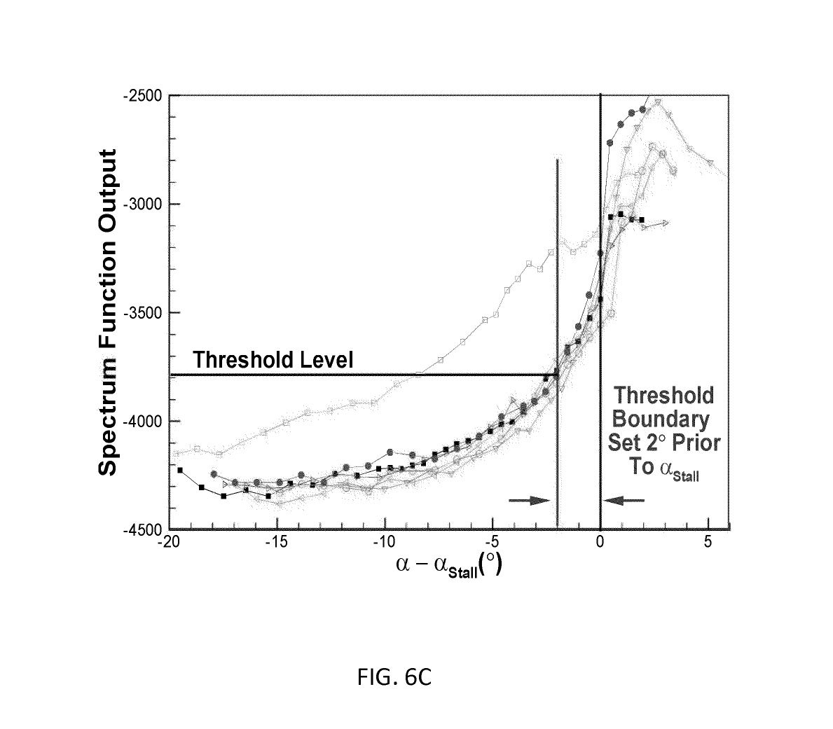

In order for the detection functions to be useful for predicting stall, the example functions should provide a consistent output across the widest range of environmental conditions, including icing, surface contamination such as roughness or heavy rain, surface damage such as bird strikes, etc. If the output is not consistent across these (or other) different hazards, a simple threshold based approach (for example) may produce inconsistent results dependent upon the hazard. A plot showing the output of the three example detector functions for the clean NACA 3415 model and the model with all six tested simulated contaminants as a function of angle-of-attack prior to stall (α-αₛₜₐₗₗ) at Re=1.8×10⁶, flap=0° is shown in FIGS. 6A-6C, where FIG. 6A indicates the moment function output, FIG. 6B indicates the derivative function output, and FIG. 6C indicates the spectrum function output.

From FIGS. 6A-6C, the output for each of the three separate detector functions for the clean model and the model with all six simulated contaminants collapse onto a single curve with the exception of the simulated upper surface damage case. As a result, a simple threshold can be set for each of the detector functions based on a warning boundary a set number of degrees prior to αₛₜₐₗₗ. For the example data shown, there appears to be enough signal in the detector function outputs to provide a boundary warning range of 1° to 4° prior to actual stall. In the occurrence of an inconsistency between one detector function and the other two detector functions, the difference of stall margin could be used to determine or deduce whether or not an error has occurred in one of the detector functions, since the three example detector functions estimate the stall margin with methods unique to that detector function. If the deviation between the stall margins provided by one of the detector functions and the average of the other two detector functions is too large, a case system could be implemented to remove the outlying detector function output from the averaging process.

For the data shown in FIGS. 6A-6C, for example purposes, a threshold level is chosen to provide a warning 2° prior to stall. This single threshold (for each detector function) would appear to provide a relatively accurate warning boundary for all the cases shown, with the exception of the simulated upper surface damage case. The upper surface damage case does not collapse well due to its isolated 3D nature on the model surface. While premature separation may have occurred in the spanwise region of the protuberances, other spanwise regions of the model would not have experienced the perturbation from the simulated damage. For the current set of data used for these examples, a floor-mounted force and moment balance was used to obtain the lift and quarter-chord pitching moment measurements. Since the sectional lift was calculated from the wind tunnel floor balance, the entire span of the model was included in the example measurement. As a result, the overall loss in lift for the upper surface damage case is relatively small, and αₛₜₐₗₗ is relatively unchanged.

Again, this example set-up mimics what would be observed on an aircraft wing where the effect of an isolated structural incident would be integrated over the entire control surface. This fact, coupled with the relatively close chordwise proximity of the simulated damage to the flap, produces an elevated detector function output that does not collapse like the other simulated contaminants While the single threshold approach would produce a premature boundary warning for this example case, the example system would alert the user to a change in the aerodynamics of the configuration, and the location of the issue. Overall, however, the example detector functions developed work well across all but one of the contaminants tested.

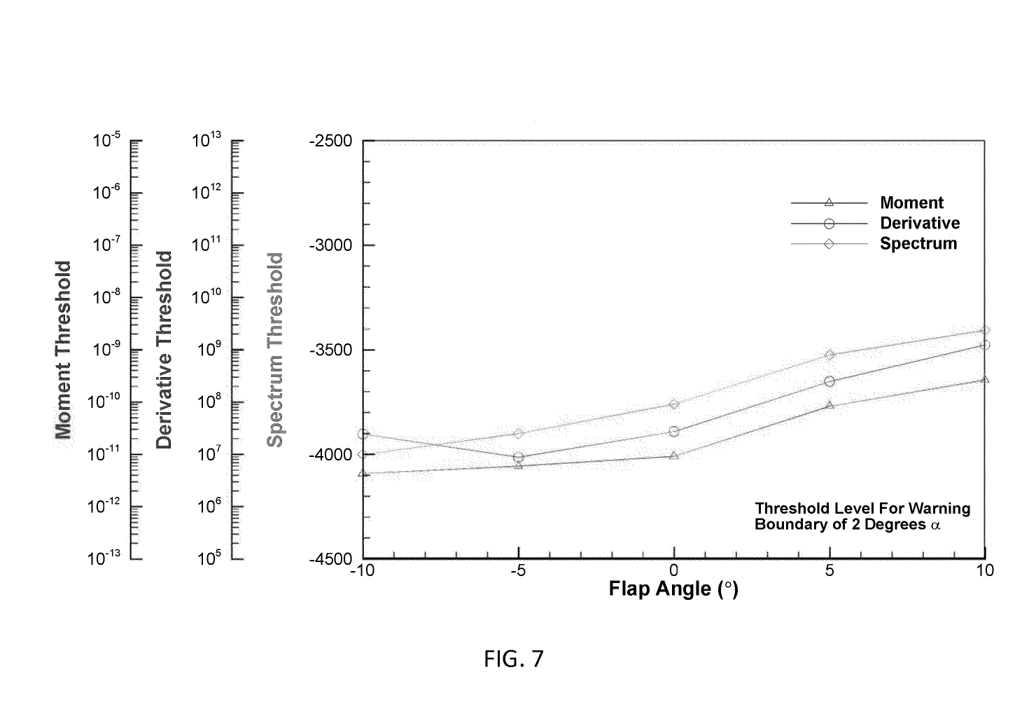

The example threshold level is observed to be a function of flap angle. The threshold level as a function of flap deflection for a stall warning boundary of 2° for each of the three example detector functions at Re=1.8×10⁶ is shown in FIG. 7. In order to give a correct representation of the magnitude of the threshold level change as a function of flap angle, the vertical scales for the threshold levels shown in FIG. 7 are identical to those shown in FIGS. 6A-6C and FIG. 5. From FIG. 7, the example threshold level is shown to be a moderate function of flap angle, with the threshold level generally increasing with increasing positive flap deflection.

In an example hinge moment monitoring system, the individual stall boundary warnings produced by the three separate example detection functions are averaged to provide a single stall boundary warning The averaging of the three separate functions provides a level of redundancy in the calculation to minimize the influence of outliers in the data that might appear in one of the functions. A standard deviation calculation between the three different methods computed in real-time could also be used as a measure of the confidence in the stall boundary warning prediction.

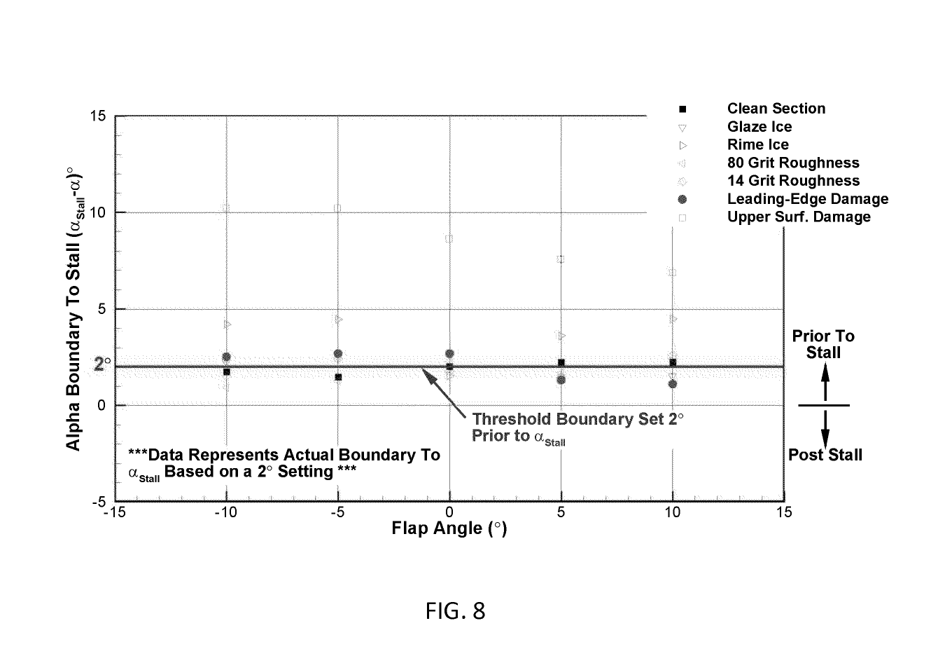

Based on the threshold levels shown in FIG. 7 for an envelope boundary warning of 2°, stall warning boundaries were generated for the clean NACA 3415 model, and the model with all six of the example contaminants tested at Re=1.8×10⁶ for the five flap deflections tested. The example predicted stall warning boundaries as a function of flap angle are shown in FIG. 8.

The results shown in FIG. 8 indicate the magnitude of the angle-of-attack value prior to stall produced by the average of the three stall warning prediction functions. A value of 2° would indicate a perfect correlation to the set warning boundary. A value above 2° indicates the example detection function produced a boundary warning at an angle-of-attack lower than the set 2° prior to stall, with a value below 2° indicating a boundary warning closer to stall than the set value. As shown in FIG. 8, for the majority of the cases the example detection function produces a warning within ±0.7° of the set boundary value.

The two cases which fall outside of this range are the rime ice and upper surface damage cases. The results for the upper surface damage case are as expected, based on the results shown in FIGS. 6A-6C, as described above. The second outlying data set is that of the simulated rime ice case. The simulated rime ice case produces a warning approximately 2° prior to the example set 2° warning mark (4° prior to stall). This premature warning is due to the rime case producing a larger unsteadiness in the hinge moment output than the other example cases.

Overall, across the wide range of simulated contaminants tested, the example functions used for stall warning prediction functioned well. All of the warnings produced were prior to actual stall. The largest outliers produced a conservative error, prior to the set warning boundary.

In addition to the three example detection functions shown, an additional type of detection function can be provided in particular embodiments of the invention. This additional example type of detection addresses potential concerns about the reliability of the derivative based detection function in a noisy flight environment, even though the data are preferably filtered (e.g., low-pass filtered) before being operated upon. An example additional function determines time normalized energy of the hinge moment signal. This example function can operate in the same fashion as the moment, spectrum, and derivative functions in question.

The experimental data and results presented in these nonlimiting examples has been for a single Reynolds number, Re=1.8×10⁶. Data were also obtained in other examples at Re=1.0×10⁶. The lower Reynolds number data closely matches the higher Re data. At these low Reynolds numbers, the differences between these two cases are primarily laminar/turbulent transition based. For vehicles using the example hinge moment detection system, minimum Reynolds numbers would most likely be in the 6 to 8 million range where transition is most likely very near the leading edge. For the example cases run, the lower Reynolds number results closely mimic the Re=1.8×10⁶ results. The threshold levels for the Re=1.0×10⁶ results are slightly lower than those obtained for the Re=1.8×10⁶ cases, with the overall results being similar At the higher Reynolds numbers experienced on actual flight vehicles, where transition is more closely fixed near the leading edge, it is conceivable that there may be no Reynolds number effect due to the fact that the hinge moment data are reduced to coefficient form (dynamic pressure taken into account).

Another set of example detection functions were developed using data from the NACA 23012 model. These functions utilize wavelet based analyses, according to another example embodiment of the present invention. Theoretically, the unsteady hinge moment signal, e.g., the unsteady hinge moment coefficient, can be thought of as two convolved signals: a mean signal based on the steady pressure distribution and steady forcing from processes such as the Karman street shed from the trailing-edge, and an unsteady signal based on eddies shed from separation bubbles, separated shear layers, and boundary layers approaching incipient separation. In order to isolate the unsteady content of the signal generated by the separation, the signal might be de-convolved, or the mean and steady forcing filtered out. A wavelet based denoising technique is used in example embodiments to attempt to isolate the unsteady separation dominated hinge moment signal.

Unlike a continuous periodic function, such as a sine or cosine wave, a wavelet is a wave-like function whose amplitude starts and ends at zero. Wavelets are generally designed to have specific properties and shapes, depending upon their use. They are commonly used for advanced signal processing and filtering techniques. A wavelet with a given shape and properties can be convolved with a signal. If the unknown signal contains information similar to the wavelet, the wavelet will resonate, much like a tuning fork resonates with sound waves of its specific tuning frequency. As a result, wavelet analysis can be used according to embodiments of the present invention to capture the transient features of a signal.

One example technique is called wavelet denoising. In denoising, a given signal is essentially filtered to remove unwanted information and highlight certain aspects of the signal. Wavelet denoising is done in three primary steps: 1) a linear forward wavelet transform is performed; 2) a nonlinear denoising is performed, where the transformed signal is thresholded in the waveform domain using any different number of thresholding techniques; and 3) finally, a linear inverse wavelet transform is performed to retrieve the denoised signal. In order to perform the wavelet denoising in example embodiments a “mother” wavelet is chosen. The mother wavelet contains the signal characteristics of interest. Generally, the mother, or primary, wavelet is developed based upon the transient features one desires to highlight.

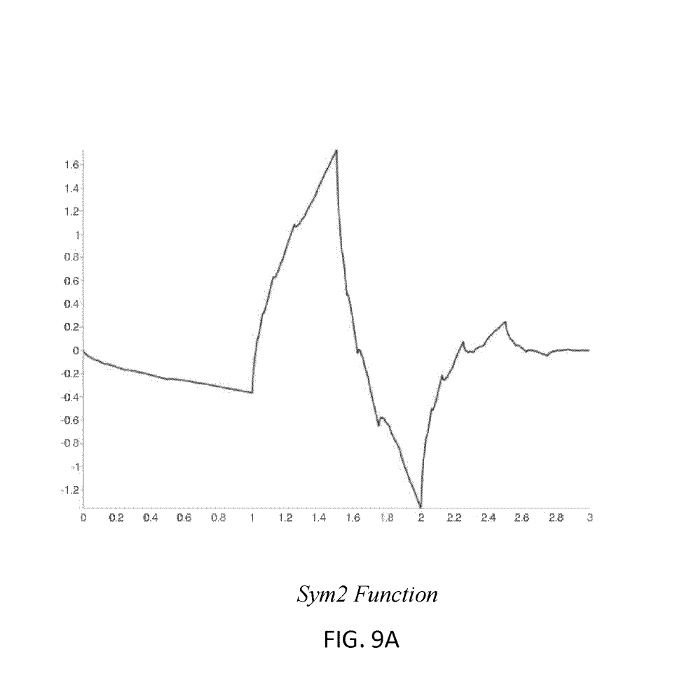

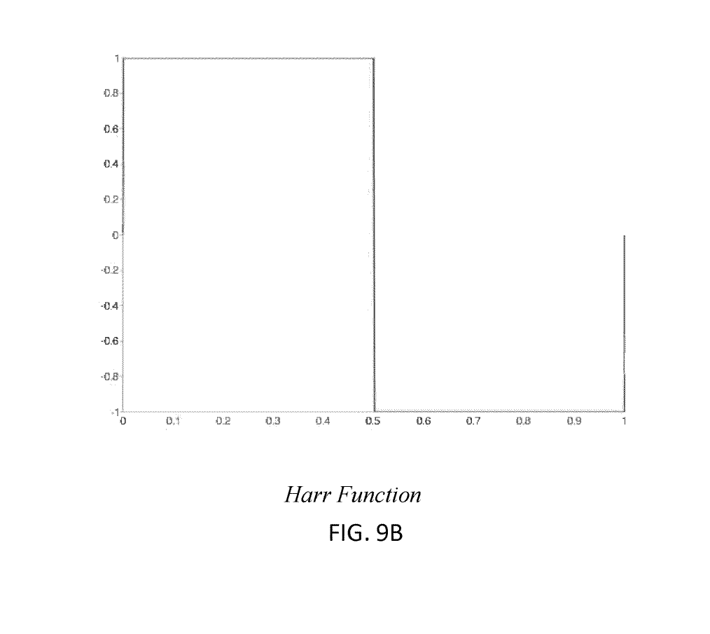

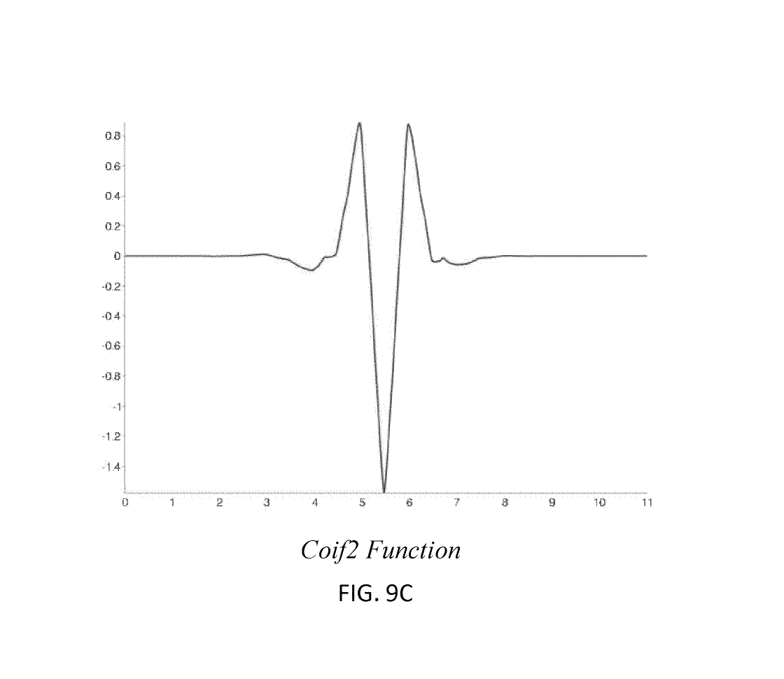

In an example method, several wavelet denoising routines present in the National Instruments LabVIEW acquisition and analysis environment were used to determine the viability of using wavelets to isolate the unsteady separation content of the hinge moment signal. In the absence of a mother, or primary, wavelet specifically developed for the unsteady hinge moment signal, various primary wavelets available in the LabVIEW denoising routines were tested. Wavelets were tested by processing the unsteady hinge moment signal at several angles-of-attack well below stall, then at the set warning boundary angle-of-attack, and post stall. Wavelets were chosen that provided relatively no signal output prior to the warning boundary angle-of-attack, yet produced significant output at the warning boundary angle-of-attack. As a nonlimiting example, for the NACA 23012 data, these wavelets included the Sym2, Haar, and Coif2 wavelets. Images of the three wavelet functions are shown in FIGS. 9A, 9B, and 9C respectively.

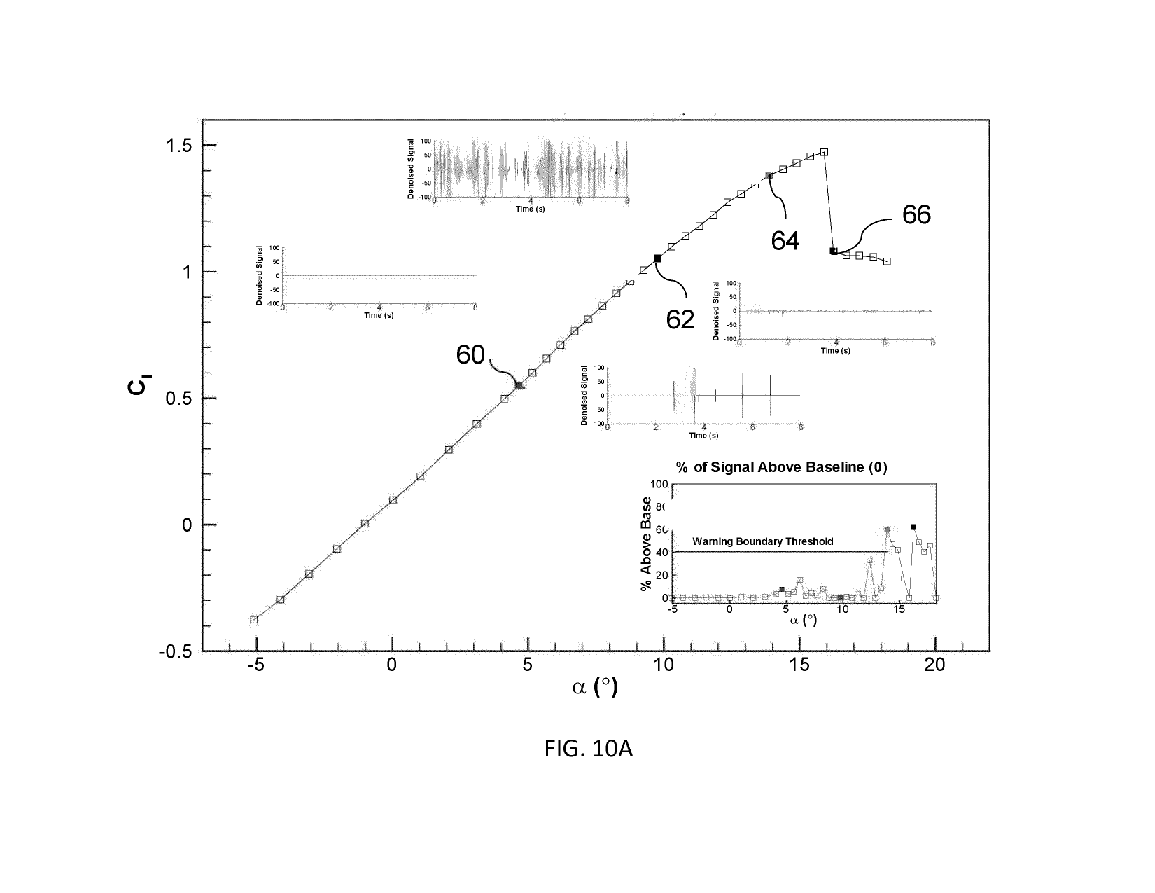

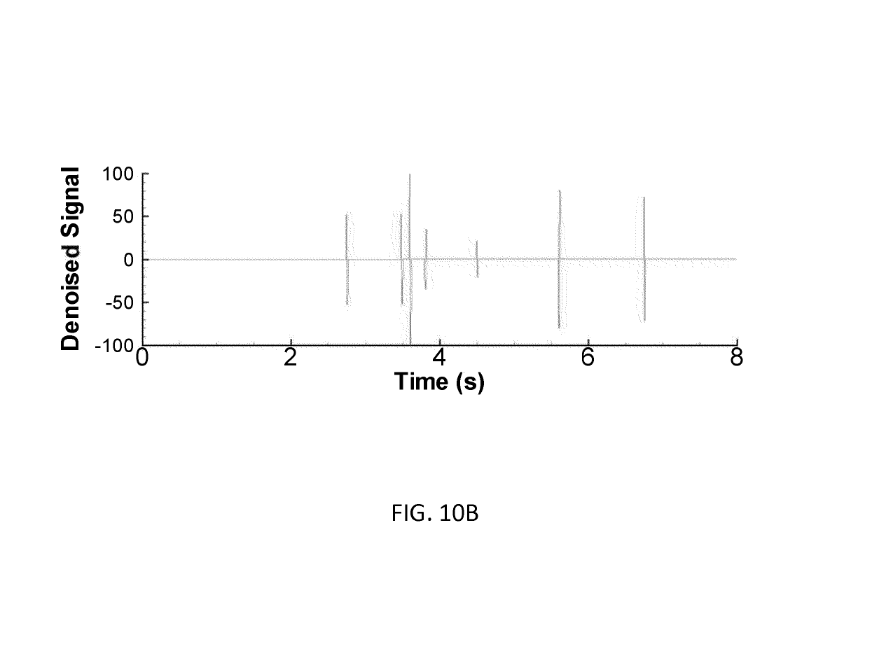

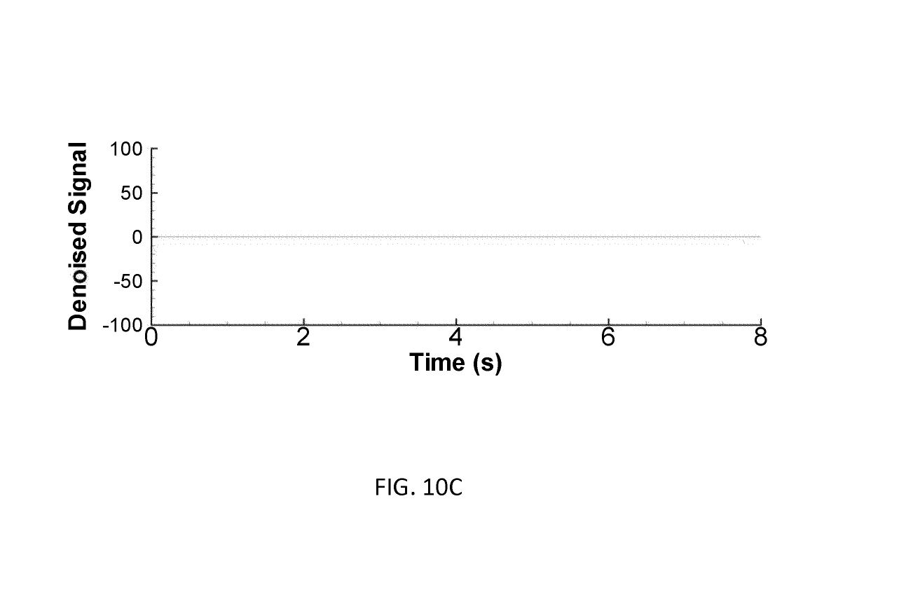

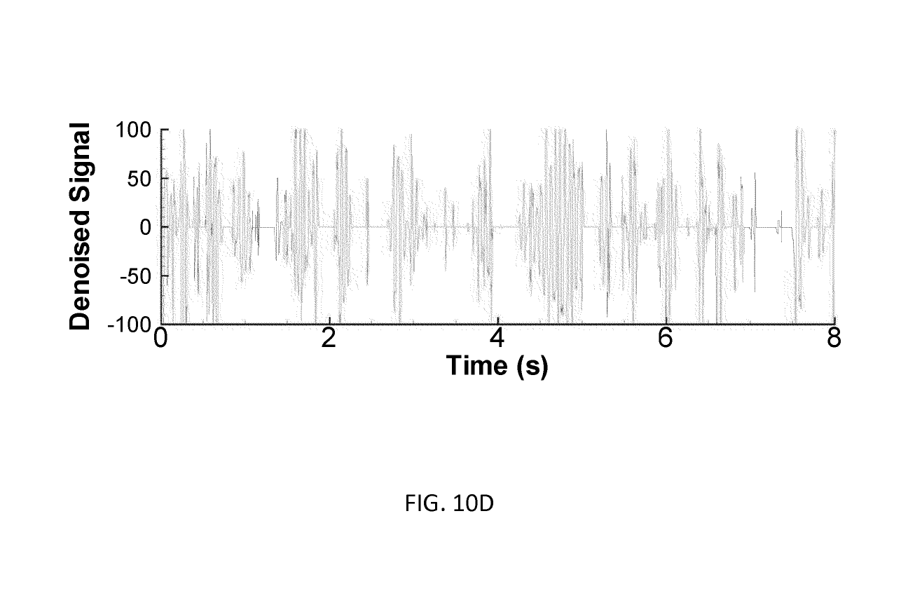

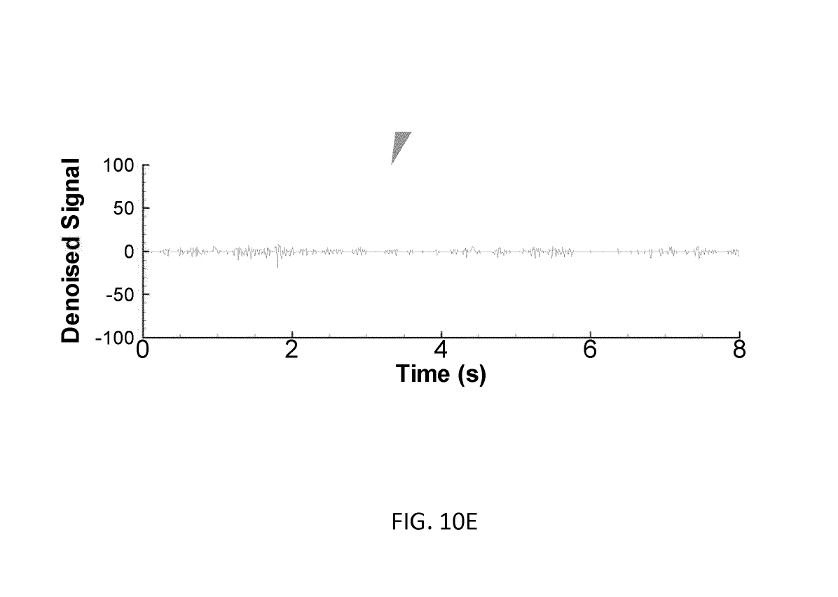

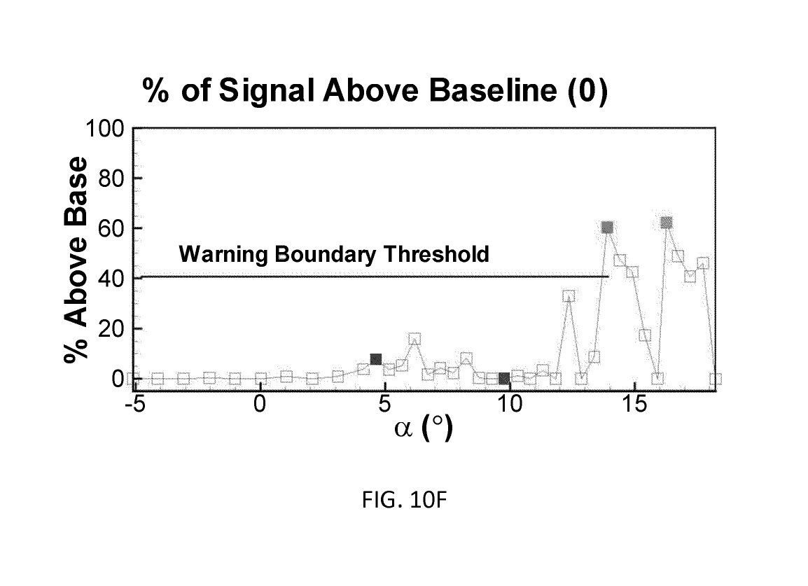

Much like the three different example detector functions developed for the NACA 3415 data, the three example primary wavelets were used to develop a stall warning prediction. The example function passes the unsteady hinge moment signal through the wavelet denoising transform. The absolute value of the output from the transform is then passed through a baselining process, where any signal above zero is converted to a nominal value. The total percentage of the signal above zero is then calculated. A threshold based on the total percentage value of the signal above zero is then used to determine the warning boundary. As with the NACA 3415 data, before the data were processed using the wavelet transforms, the data were low-pass filtered at 50 Hz to minimize the effect of structural frequencies. A plot showing the clean NACA 23012 lift curve is shown in FIG. 10A, and outputs from the Haar based wavelet transform for selected points 60, 62, 64, 66 are shown in FIGS. 10B, 10C, 10D, and 10E respectively.

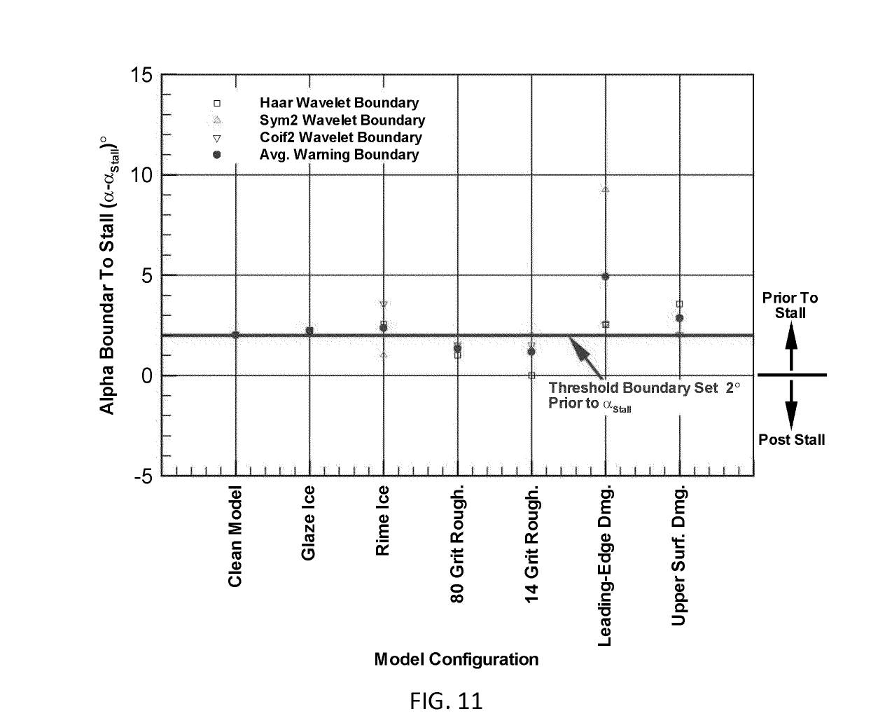

Also shown in FIG. 10F is the graph showing the percentage of the signal above the baseline zero value. From FIG. 10F, at low angles-of-attack, there is only minor, scattered response present in the example wavelet transform output. At moderate angles of attack (α≈9°), no response is present in the signal. At the prescribed warning boundary of 2° prior to stall (α≈13.9°), the example wavelet transform produces significant output. Post stall (α≈16.2°), the magnitude of the output has reduced significantly, but signal is still present. The example wavelet denoising transform appears to be extracting the separation based content of the hinge moment signal. While the magnitude of the output greatly decreases past stall, the signal is still present. Using the approach of calculating the percentage of the signal above a zero baseline allows a normalization of the signal output. FIG. 10F, showing the percentage of the signal above the baseline zero value, shows very little behavior below stall, and begins to grow rapidly around the 2° warning boundary. A threshold is then chosen based on the desired warning boundary. Warning boundaries calculated using the three different example primary wavelets for a 2° pre-stall boundary for the clean NACA 23012 model and the model with the six simulated contaminants are shown in FIG. 11, along with the average of the three example wavelet prediction methods.

As shown in FIG. 11, the example wavelet based prediction method functions well for the NACA 23012 model with no flap deflection. The average boundary prediction error produced by three example wavelet functions is under ±0.5°. The function also worked well for the simulated damage cases. Only one significant outlier point exists for the Sym2 wavelet prediction of the simulated leading-edge damage case. While the example functions and methodologies developed for the NACA 23012 section with zero flap angle appear to function well, the results for the flap deflected section tends to under predict the stall angle by several degrees and are noisier. To more accurately extend the analysis to the other flap deflections, a custom wavelet can be developed based upon the hinge moment signal. In order to develop a custom wavelet, aerodynamic forcing frequencies may need to be determined so that they could be accurately extracted using the example transform based approach.

A significant application of the example wavelet method is that different wavelets can be developed for different types of stalling characteristics or hazards. Results from any section might also be filtered using multiple wavelets. If a given wavelet is tuned to a certain type of stalling characteristic, the output of that wavelet transform should be able to identify that stalling characteristic, where the other wavelets should produce a null output. An example multiple wavelet method could allow a family of wavelets to be developed, which would allow the example wavelet detection method to be applicable across a very wide range of sections with very different stalling characteristics and aerodynamic hazards.

Overall, the example predictive stall warning detection functions developed based on the unsteady hinge moment signal appear to provide various features and benefits. For example, the three example detection functions developed for the NACA 3415 results functioned well across the wide range of simulated contaminants tested. For the majority of the cases, the detection function produces a warning within ±0.7° of the set boundary value. The averaging of the three separate example functions provides a level of redundancy in the calculation, and can also be used as a measure of the confidence in the example stall boundary warning prediction. Additionally, there appears to be sufficient signal in example methods to extend the stall warning boundary further, e.g., out to 3°-4° prior to stall. Although not used in this experimental analysis, the example fourth detection function can be developed and used based on the time normalized energy of the signal, as explained above, to address concerns of using the derivative based approach on noisier flight-based hinge moment measurements.

Much like the example predictive stall warning detection functions, three different primary wavelet based approaches were used in another example embodiment to generate stall warning boundaries, and the results were averaged to produce a single warning The results produced for the NACA 23012 with and without the simulated contaminants at Re=1.8×10⁶ and no flap deflection produced beneficial results. The average boundary prediction error produced by the three example wavelet functions was under ±0.5°. While the example wavelet based prediction function was shown to function well for some cases, e.g., undeflected flap case, to accurately extend the wavelet based analysis to the other flap deflections a custom wavelet, or family of wavelets based upon the hinge moment signal, may be provided. This may allow the wavelet based detection method to be applicable across a very wide range of sections with very different stalling characteristics and aerodynamic hazards.

While example methods are described with respect to a 2D environment, it is also contemplated that methods can be extended to a 3D finite wing with multiple control surfaces to function in a more complex environment. Also, though particular custom wavelets can be used, it is also contemplated that a uniform envelope prediction system could be provided according to embodiments of the present invention to function across multiple platforms based on different sections.

Nonlimiting example applications of the present invention are regional and commercial aircraft manufacturing, and vehicle aerodynamic health monitoring system manufacturing.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

What is claimed is:

1. A method for predicting airfoil stall for an aircraft having a control surface, the method comprising:
measuring forces or moments acting upon an integrated span of the control surface over a period of time to provide unsteady data;
filtering said unsteady data to remove structural frequencies and provide filtered unsteady data;
inputting said filtered unsteady data to at least one stall warning detection function and receiving an output of the at least one stall warning detection function, each of the at least one stall warning detection function identifying an angle-of-attack that is approximately within a predetermined number of degrees of stall when the received output reaches a threshold;
comparing said output to the threshold to determine whether an angle-of-attack exists that is near stall.

2. A method for predicting airfoil stall for an aircraft having a control surface connected to a hinge, the method comprising:
sensing a control surface hinge moment about the hinge over a period of time;
determining unsteady hinge moment data over the period of time based on said sensed control surface hinge moment;
filtering said determined unsteady hinge moment data to remove structural frequencies and provide filtered unsteady hinge moment data;
inputting said filtered unsteady hinge moment data to at least one stall warning detection function and receiving an output of the at least one stall warning detection function, each of the at least one stall warning detection function identifying an angle-of-attack that is approximately within a predetermined number of degrees of stall when the received output reaches a threshold;
comparing said output to the threshold to determine whether an angle-of-attack exists that is near stall.

3. The method of claim 2, wherein said filtering comprises filtering said determined unsteady hinge moment data through a filter having a band determined based on structural frequencies capable of influencing hinge moment measurements.

4. The method of claim 2, wherein said determining comprises:
acquiring a plurality of sensed control surface hinge moment signals over the period of time; and
non-dimensionalizing the plurality of hinge moment signals using data from aircraft sensors to provide a plurality of unsteady hinge moment coefficients.

5. The method of claim 4
wherein said filtering said determined unsteady hinge moment data provides a plurality of filtered unsteady hinge moment coefficients.

6. The method of claim 5, wherein the at least one stall warning detection function comprises a plurality of stall warning detection functions;
wherein said receiving an output comprises receiving an output for each of the plurality of stall warning detection functions and combining the received outputs to provide a combined output;
wherein said comparing said output to the threshold comprises comparing the combined output to the threshold.

7. The method of claim 6, wherein the plurality of stall warning detection functions comprise the following, where Cₕ is the filtered unsteady hinge moment coefficient, n is a number of filtered unsteady hinge moment coefficients over the period of time being considered, and PSD=power spectrum density:
$$\begin{matrix}Moment = \frac{1}{n} {\sum }_{i = 0}^{n - 1} {( {C}_{h} - {\overline{C}}_{h} )}^{4} & 1 st Function \\ Derivative = \frac{1}{n} {\sum }_{i = 0}^{n - 1} {( \frac{d {C}_{h}^{2}}{d t} + \frac{{d}^{2} {C}_{h}^{2}}{d {t}^{2}} )}^{2} & 2 nd Function \\ Spectrum = {\int }_{0 Hz}^{50 Hz} PSD ( {C}_{h} ) d f & 3 rd Function\end{matrix}$$

8. The method of claim 7, wherein the plurality of stall warning detection functions further comprise a function that determines time normalized energy of the filtered unsteady hinge moment coefficients.

9. The method of claim 6, wherein said combining the received outputs comprises averaging the received outputs.

10. The method of claim 6, wherein receiving an output of each of the plurality of stall warning detection functions comprises:
performing a linear forward wavelet transform on the filtered unsteady hinge moment coefficient to provide a transformed signal:
performing nonlinear wavelet transform on the transformed signal using a mother wavelet selected to isolate unsteady separation content and provide a denoised signal; and
performing a linear inverse wavelet transform on the denoised signal.

11. The method of claim 1, wherein the control surface comprises one or more of ailerons, rudders, elevators, and flaps of the aircraft.

12. An apparatus for predicting airfoil stall for an aircraft control surface, comprising:
at least one sensor for sensing a control surface hinge moment over a period of time;
a processor coupled to said at least one sensor, said processor being configured to receive the sensed control surface hinge moment over the period of time from said at least one sensor and determine whether an angle-of-attack exists that is near stall, said processor being configured to perform a method comprising:
determining unsteady hinge moment data over the period of time based on said sensed control surface hinge moment;
filtering said determined unsteady hinge moment data to remove structural frequencies and provide filtered unsteady hinge moment data;
inputting said filtered unsteady hinge moment data to at least one stall warning detection function and receiving an output of the at least one stall warning detection function, each of the at least one stall warning detection function identifying an angle-of-attack that is approximately within a predetermined number of degrees of stall when the received output reaches a threshold;
comparing said output to the threshold to determine whether an angle-of-attack exists that is near stall.

13. The apparatus of claim 12, wherein said filtering comprises filtering said determined unsteady hinge moment data through a filter having a band determined based on structural frequencies capable of influencing hinge moment measurements.

14. The apparatus of claim 12, wherein said determining comprises:
acquiring a plurality of sensed control surface hinge moment signals over the period of time; and
non-dimensionalizing the plurality of hinge moment signals using data from aircraft sensors to provide a plurality of unsteady hinge moment coefficients.

15. The apparatus of claim 14
wherein said filtering said determined unsteady hinge moment data provides a plurality of filtered unsteady hinge moment coefficients.

16. The apparatus of claim 15, wherein the at least one stall warning detection function comprises a plurality of stall warning detection functions;
wherein said receiving an output comprises receiving an output for each of the plurality of stall warning detection functions and combining the received outputs to provide a combined output;
wherein said comparing said output to the threshold comprises comparing the combined output to the threshold.

17. The apparatus of claim 16, wherein the plurality of stall warning detection functions comprise the following, where Cₕ is the filtered unsteady hinge moment coefficient, n is a number of filtered unsteady hinge moment coefficients over the period of time being considered, and PSD=power spectrum density:
$$\begin{matrix}Moment = \frac{1}{n} {\sum }_{i = 0}^{n - 1} {( {C}_{h} - {\overline{C}}_{h} )}^{4} & 1 st Function \\ Derivative = \frac{1}{n} {\sum }_{i = 0}^{n - 1} {( \frac{d {C}_{h}^{2}}{d t} + \frac{{d}^{2} {C}_{h}^{2}}{d {t}^{2}} )}^{2} & 2 nd Function \\ Spectrum = {\int }_{0 Hz}^{50 Hz} PSD ( {C}_{h} ) d f & 3 rd Function\end{matrix}$$

18. The apparatus of claim 17, wherein the plurality of stall warning detection functions further comprise a function that determines time normalized energy of the filtered unsteady hinge moment coefficients.

19. The apparatus of claim 16, wherein receiving an output of each of the plurality of stall warning detection functions comprises:
performing a linear forward wavelet transform on the filtered unsteady hinge moment coefficient to provide a transformed signal:
performing nonlinear wavelet transform on the transformed signal using a mother wavelet selected to isolate unsteady separation content and provide a denoised signal; and
performing a linear inverse wavelet transform on the denoised signal.

20. The apparatus of claim 12, wherein the control surface comprises one or more of ailerons, rudders, elevators, and flaps of the aircraft.

21. The apparatus of claim 12, further comprising:
a display device or alarm coupled to said processor for indicating a warning if said processor determines that the angle-of-attack is near stall.
